(19) United States
(12) Patent Application Publication
(10) Pub. No.: US 2005/0162014 A1
(43) Pub. Date: Jul. 28, 2005

(54) Actuator

(76) Inventors: Satoshi Morizaki, Toyokawa-shi (JP); Masahiro Takeda, Toyohashi-shi (JP)

Correspondence Address: SHERIDAN ROSS PC, 1560 BROADWAY, SUITE 1200, DENVER, CO, 80202, US

(21) Appl. No.: 10/810,162

(22) Filed: Mar. 26, 2004

(30) Foreign Application Priority Data
Apr. 2, 2003 (JP) 2003-099666

(51) Int. Cl. B60L 1/00

(52) U.S. Cl. 307/10.1

(57) ABSTRACT

An actuator having satisfactory responsiveness. The actuator includes an input terminal, an output terminal, a switch connected between the output and input terminals, a driving portion, and a control circuit. When reset, the control circuit sets an initial value and opens the switch to disconnect the input and output terminals from each other. When the control circuit receives a control signal including a predetermined value, the control circuit changes the initial value to the predetermined value, which is used as the address value of the actuator and closes the switch to connect the input and output terminals to each other.

### BACKGROUND OF THE INVENTION

The present invention relates to an actuator, and more particularly, to a plurality of actuators controlled independently of one another, an actuator system including a plurality of actuators, and a method for controlling an actuator.

A typical actuator system, such as one used in a vehicle air conditioner, includes a plurality of actuators, each having a driving portion. The actuator system drives the driving portions of the actuators independently of one another. In such an actuator system, an address is set for each actuator. Further, the actuators are connected to one another and to a master controller through a local area network (LAN). The LAN decreases the number of wires in the actuator system.

Japanese Patent No. 2568070 describes an actuator system including a plurality of daisy chain connected actuators. In this actuator system, the address of each actuator is sequentially set by a control signal from the master controller.

More specifically, in this actuator system, the address of each actuator is initialized to an initial value when the actuator system is reset. The controller then sequentially transmits a control signal (address setting signal) to set the addresses of the actuators. When the address of an actuator is an initial value, the address setting signal sets the address of the actuator to a predetermined value. Further, when an actuator receives the address setting signal, the actuator stores the address setting signal and determines whether the address included in the address setting signal is addressed to itself. If the address setting signal is addressed to itself, the actuator performs command processing (address setting) on the address setting signal. If the address setting signal is not addressed to itself, the actuator provides the actuator in the next stage with the stored address setting signal.

In this manner, when the controller provides the first address setting signal to a first actuator (the actuator closest to the controller), the address value of the first actuator is set at a predetermined value. Then, the controller provides a second address setting signal (signal addressed to a second actuator, which is the stage connected next to the first actuator) to the first actuator, of which address value has already been set. The second address setting signal is not addressed to the first actuator. Thus, the first actuator provides the stored control signal to the second actuator in the next stage. As a result, the second actuator sets its address value from the initial value to a predetermined value (value differing from the address value of the first actuator). Such processing is repeated to set a different predetermined address value for each actuator. In such an actuator system, the actuators do not have to be provided with different identification (ID) numbers. Accordingly, there is no need for a circuit to set the ID numbers (e.g., there is no need to configure a pattern corresponding to the addresses of the actuators on a substrate incorporated in each of the actuators).

In the actuator system, a control signal (drive command signal) for controlling a driving portion (motor) of each actuator is provided to each actuator after the address is set. The actuator processes the drive command signal in the same manner as the address setting signal. In other words, when receiving the drive command signal, the actuator stores the drive command signal (storage process) and determines whether an address included in the drive command signal is addressed to itself (determination process). If the drive command signal is addressed to itself, the actuator performs a command process on the drive command signal (drive control of the driving portion). If the drive command signal is not addressed to itself, the actuator provides the stored drive command signal to the actuator in the next stage (transmission process). In this manner, each actuator always performs the storage, determination, and transmission processes even when receiving a drive command signal that is not addressed to itself. This increases the load applied to ICs (control circuits) that perform these processes. Further, the time for each processing delays the drive command signal that is sent to the actuator in the following stage. Therefore, in an actuator system provided with a large number of actuators, the response of the actuator in the final stage (the actuator farthest from the controller) is especially unsatisfactory.

### SUMMARY OF THE INVENTION

It is an object of the present invention to provide an actuator, an actuator system, and a method for controlling an actuator that improves responsiveness.

To achieve the above object, the present invention provides an address setting device for setting an address of a device in accordance with a control signal. The setting device includes an input terminal for receiving the control signal. An output terminal outputs the control signal. A setting circuit, connected to the input terminal and the output terminal, sets an address value. The setting circuit sets an initial value and disconnects the input and output terminals from each other when reset. When the received control signal includes a predetermined value, the setting circuit changes the initial value to the predetermined value, which is used as the address value, and connects the input and output terminals to each other.

A further aspect of the present invention is an actuator for which an address value is set based on a control signal. The actuator includes an input terminal for receiving the control signal. An output terminal outputs the control signal. The actuator also includes a driving portion. A control circuit, connected to the input terminal, the output terminal, and the driving portion, controls the driving portion in accordance with the control signal. The control circuit sets its address value in accordance with the control signal. The control circuit sets an initial value and disconnects the input and output terminals from each other when reset. When the received control signal includes a predetermined value, the control circuit changes the initial value to the predetermined value, which is used as the address value of the actuator, and connects the input and output terminals to each other.

A further aspect of the present invention is an actuator system including a plurality of series-connected actuators. An address value is set for each of the actuators. A master controller, connected to the actuators, provides the actuators with a control signal. Each of the actuators includes an input terminal for receiving the control signal, an output terminal for outputting the control signal, a driving portion, and a control circuit, connected to the input terminal, the output terminal, and the driving portion, for controlling the driving portion in accordance with the control signal and for setting the address value of the actuator in accordance with the control signal. The control circuit sets an initial value and disconnects the input and output terminals from each other when reset. When the received control signal includes a predetermined value, the control circuit changes the initial value to the predetermined value, which is used as the address value, and connects the input and output terminals to each other.

A further aspect of the present invention is an actuator system for use in a vehicle air conditioner having air doors. The actuator system includes a plurality of series-connected actuators, each being arranged on an air door to drive the air door. An address value is set for each of the actuators. A master controller, connected to the actuators, provides the actuators with a control signal. Each of the actuators includes an input terminal for receiving the control signal, an output terminal for outputting the control signal, a driving portion, and a control circuit, connected to the input terminal, the output terminal, and the driving portion, for controlling the driving portion in accordance with the control signal and for setting the address value of the actuator in accordance with the control signal. The control circuit sets an initial value and disconnects the input and output terminals from each other when reset. When the received control signal includes a predetermined value, the control circuit changes the initial value to the predetermined value, which is used as the address value, and connects the input and output terminals to each other.

A further aspect of the present invention is a method for controlling a plurality of series-connected actuators, each including an input terminal and an output terminal. The method includes setting an initial value for each of the actuators and disconnecting the input and output terminals of each actuator, changing the initial value of each actuator to a predetermined value, which is used as the address value of the actuator, and connecting the input and output terminals to each other.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an actuator system according to a preferred embodiment of the present invention;

FIG. 2 is a schematic block diagram of an actuator in the actuator system of FIG. 1;

FIG. 3 is a flowchart of a process performed by a control circuit in the actuator of FIG. 2;

FIGS. 4A to 4C are diagrams illustrating the setting of addresses in the actuator system of FIG. 1; and

FIGS. 5A to 5C are diagrams illustrating the control of a motor in the actuator system of FIGS. 5A to 5C.

### DETAILED DESCRIPTION OF THE PREFERRED EMBODIMENTS

In the drawings, like numerals are used for like elements throughout.

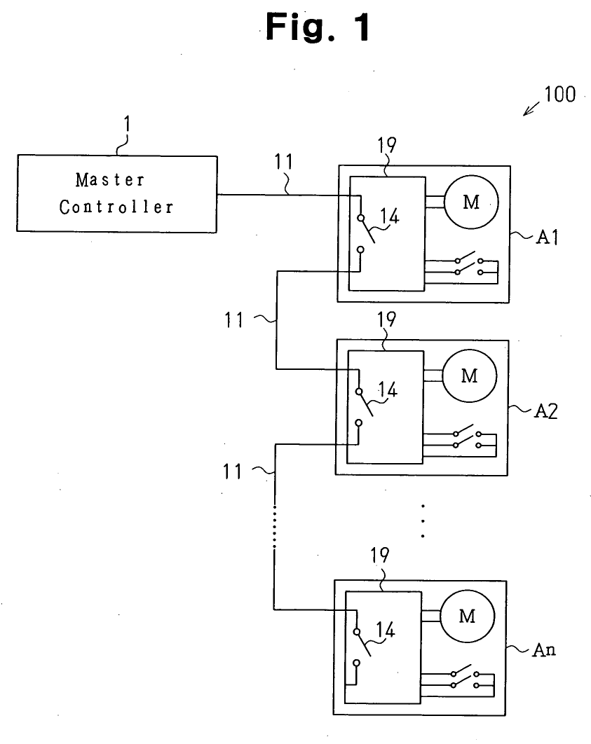

An actuator system 100 and actuators A1 to An according to a preferred embodiment of the present invention will now be discussed with reference to FIGS. 1 to 5. Referring to FIG. 1, the actuator system 100 includes a master controller 1 and a plurality of actuators A1 to An (n being the quantity of the actuators and being a positive integer that is two or greater). The actuator system 100 of the preferred embodiment is used in a vehicle air conditioner. The actuators A1 to An each drive an air door in an air conditioner passage (not shown).

The actuators A1 to An are series-connected (daisy chain connected) in the order of actuator A1, actuator A2, . . . , and actuator An to a master controller 1 by communication lines 11. Further, the actuators A1 to An are connected to the master controller by power lines (not shown).

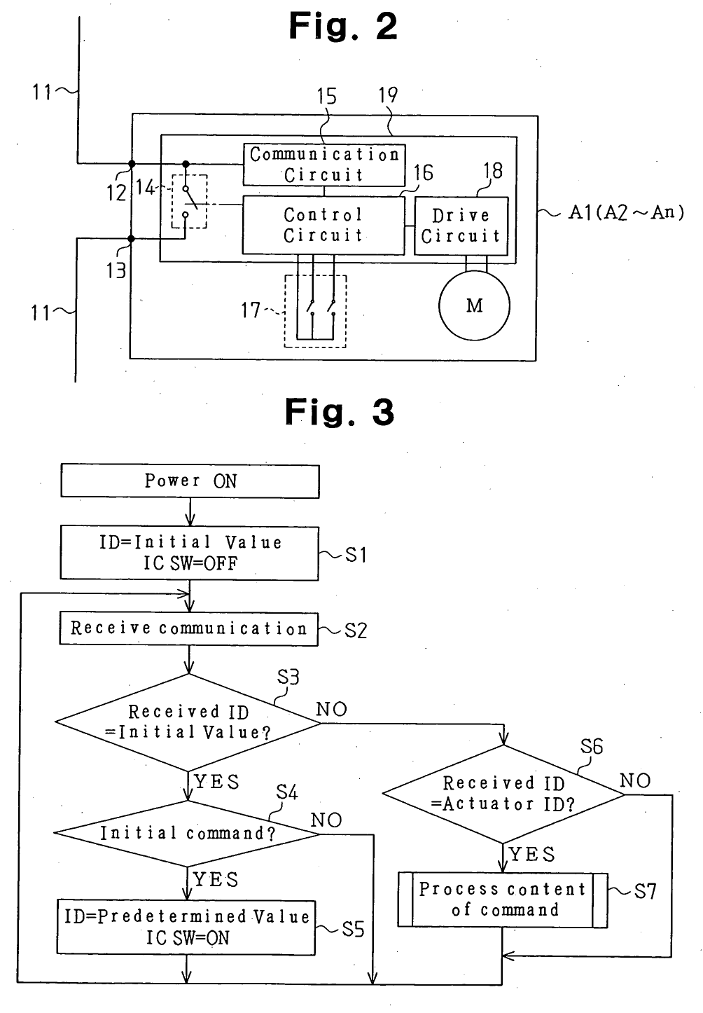

Referring to FIG. 2, each of the actuators A1 to An includes an input terminal 12, an output terminal 13, a switch 14, a communication circuit 15, a control circuit 16, a sensor 17, a drive circuit 18, and a motor M, which functions as a driving portion. In the preferred embodiment, the switch 14, the communication circuit 15, the control circuit 16, and the drive circuit 18 are integrated in a single customized control IC 19. In addition to a function for controlling the motor M, the control circuit 16 functions as a setting circuit for setting addresses in the preferred embodiment.

The switch 14 connects the input terminal 12 and the output terminal 13 to each other. The communication circuit 15 connects the input terminal 12 to the control circuit 16. The control circuit 16 is connected to the switch 14, the sensor 17, and the drive circuit 18. The drive circuit 18 is connected to the motor M.

The processing performed by the control circuit 16 will now be discussed.

When a vehicle ignition switch (not shown) is turned on, the actuator system 100 is provided with power (energized). As a result, the control circuit 16 of the preferred embodiment starts the processes of steps S1 to S7.

When the actuator system 100 is energized (power ON), in step S1, the control circuit 16 is reset (i.e., the ID number is initialized and the IC SW is inactivated). More specifically, when reset, the control circuit 16 sets its address value to an initial value (in the preferred embodiment “0”). Further, the control circuit 16 opens (inactivates) the switch 14 and disconnects the input terminal 12 from the output terminal 13.

Subsequently, the control circuit 16 waits until receiving a control signal via the input terminal 12 and the communication circuit 15. When receiving the control signal in step S2, the control circuit 16 proceeds to step S3.

In step S3, the control circuit 16 determines whether the value of the address information included in the received control signal is an initial value (in the preferred embodiment, “0”). In step S3, when the control circuit 16 determines that the value of the address information in the control signal is the initial value (in the preferred embodiment, “0”), the control circuit 16 proceeds to step S4.

In step S4, the control circuit 16 determines whether the command information included in the control signal is an initial command. An initial command is a command for setting the address value of the control circuit 16 to a predetermined value (e.g., “1”). The control signal that includes the initial command is referred to as an address setting signal. When determining that the command information is the initial command in step S4, the control circuit 16 proceeds to step S5. Further, when determining that the command information is not the initial command in step S4, the control circuit 16 proceeds to step S2.

In step S5, the control circuit 16 sets the address (i.e., the ID number is set to a predetermined number and the IC SW is activated). More specifically, the control circuit 16 replaces its initial address value (in the preferred embodiment, “0”) with a predetermined value (e.g., “1”), which is included in the control signal (i.e., address setting signal). Further, the control circuit 16 closes (activates) the switch 14 and connects the input terminal 12 and the output terminal 13 to each other. When step S5 is completed, the control circuit 16 proceeds to step S2.

In step S3, when the control circuit 16 determines that the value of the address information in the control signal is not the initial value (in the preferred embodiment, “0”), the control circuit 16 proceeds to step S6.

In step S6, the control circuit 16 determines whether the value of the address information included in the control signal is its own address value (e.g., “1”). When the control circuit 16 determines that the value of the address information included in the control signal is its own address value (e.g., “1”) in step S6, the control circuit 16 proceeds to step S7. Conversely, when the control circuit 16 determines that the value of the address information included in the control signal is not its own address value (e.g., “1”) in step S6, the control circuit 16 proceeds to step S2.

In step S7, the control circuit 16 generates a drive signal for controlling the motor M in accordance with the command information included in the control signal and a sensor signal provided from the sensor 17. The control circuit 16 provides the drive signal to the drive circuit 18. The sensor 17 of the preferred embodiment is a Hall IC for detecting the rotational angle (position) of a rotor in the motor M. When step S7 is completed, the control circuit 16 proceeds to step S2.

The operation of the entire actuator system 100 (master controller 1 and actuators A1 to An) will now be discussed.

When the vehicle ignition switch is turned ON (i.e., when the actuator system 100 is energized), the control circuit 16 of each of the actuators A1 to An executes steps S1 and S2. This sets the address value to the initial value (in the preferred embodiment, “0”) in each of the actuators A1 to An. Further, in each of the actuators A1 to An, the switch 14 is opened (inactivated), and the input terminal 12 and the output terminal 13 are disconnected from each other.

After time elapses that ensures the completion of step S1 in the actuators A1 to An from when the master controller 1 is energized, the master controller 1 sequentially transmits the first control signal (address setting signal), which sets an address. In the address setting signal, the value of the address information is the initial value (i.e., “0”), and the command information is the initial command. The master controller 1 sequentially changes the predetermined value in the initial command of the sequentially transmitted address setting information.

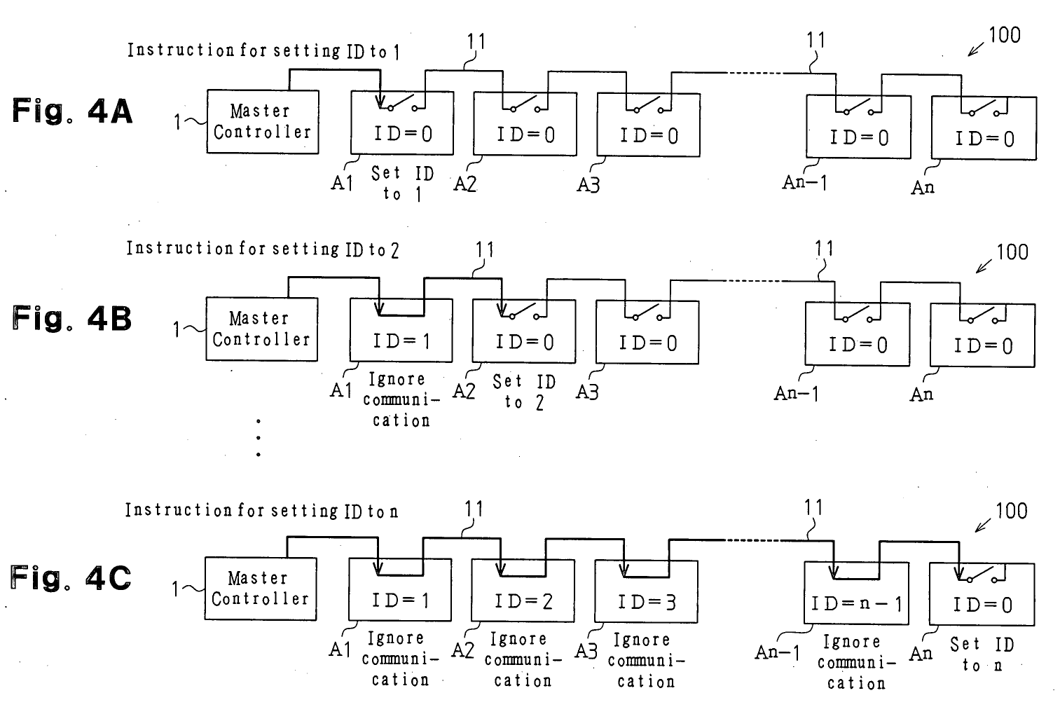

More specifically, referring to FIG. 4A, the master controller 1 of the preferred embodiment first transmits the address setting signal, in which the initial command has a predetermined value of “1” (instruction for setting the ID to 1). Then, the actuator A1 receives the address setting signal and executes steps S3 to S5. That is, the value of the address information in the control signal (address setting signal) is determined as being the initial value (step 3). Then, the command information is determined as being the initial command (step 4). Afterwards, the address value is changed from the initial value (“0”) and set to the predetermined value “1” (the ID is set to 1), and the switch 14 is closed (activated) to connect the input terminal 12 and the output terminal 13 to each other (step 5).

Then, referring to FIG. 4B, the master controller 1 transmits an address setting signal, in which the initial command has a predetermined value of “2” (instruction for setting the ID to 2). The input terminal 12 and the output terminal 13 of the actuator A1 are connected to each other. Thus, the actuators A1 and A2 receive the address setting signal. In this state, the actuator A1 executes steps S3 and S6. In other words, the actuator A1 does not take any meaningful actions (ignores communications). The actuator A2 executes steps S3 to S5. That is, in the actuator A2, the address value is set from the initial value (“0”) to the predetermined value “2” (the ID is set to 2), and the switch 14 is closed (actuated) to connect the input terminal 12 and the output terminal 13 to each other.

Referring to FIG. 4C, the master controller 1 repeats the above operations (the transmission of the address setting signal) for an n number of times (until the instruction for setting the ID to n). The transmission of the address setting signal sets the address values of the actuators A1 to An respectively to “1”, “2”, . . . , and “n” and connects all of the input terminals 12 and the output terminals 13 to one another. After step S1, the control circuit 16 in each of the actuators A1 to An waits until receiving the control signal in step S2.

When, for example, a switch (not shown) for controlling an air door is operated, the master controller 1 transmits a control signal in accordance with the switch operation.

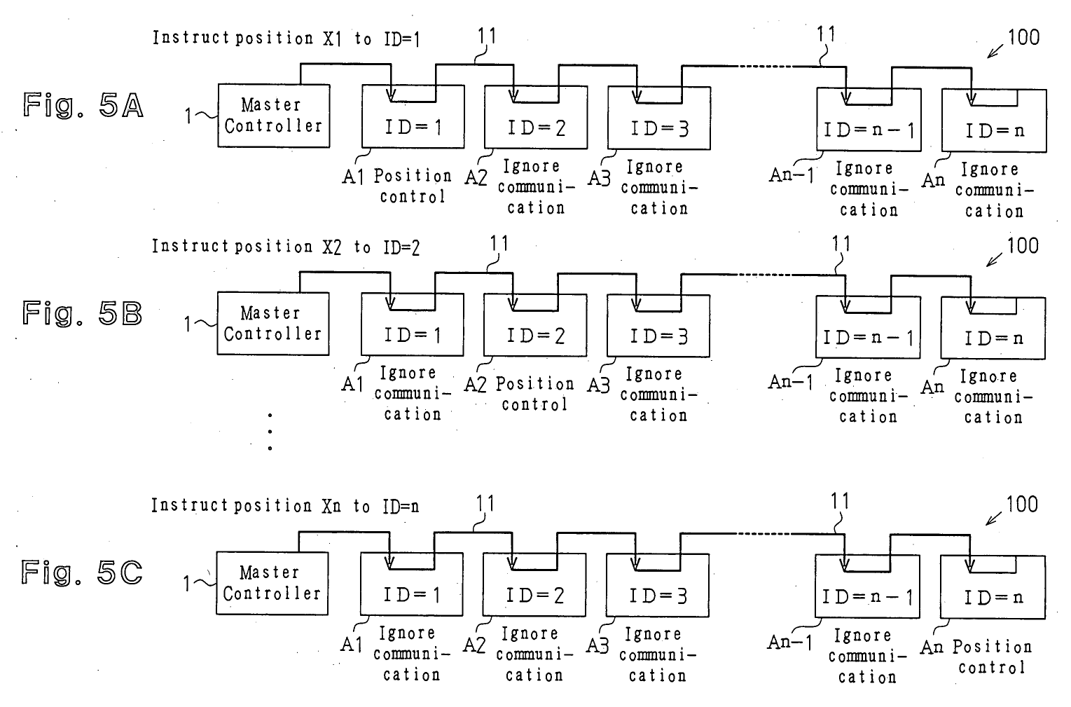

Referring to FIG. 5A, for example, in accordance with a switch operation, the master controller 1 transmits a control signal indicating that the address information value is “1” and the command information is “the rotor of the motor M is to be rotated to position X1” (giving ID 1 a position X1 instruction). The input terminals 12 and the output terminals 13 are all connected to one another. Thus, all of the actuators A1 to An receive the control signal. In the actuators A2 to An, value “1” of the address information in the received control signal does not match the actuator address value. The actuators A2 to An perform steps S3 and S6 and therefore do not take any meaningful actions (ignore communications). In the actuator A1, steps S3, S6, and S7 are executed. That is, when the value of the address information in the received control signal is determined as not being the initial value (“0”) but is determined as being its address value “1”, the drive circuit 18 is provided with a drive signal corresponding to the command information (position control). Thus, in the actuator A1, the drive circuit 18 supplies the motor M with power to rotate the rotor of the motor M to position X1 and drive the air door (open or close).

Referring to FIG. 5B, for example, in accordance with a switch operation, the master controller 1 transmits a control signal indicating that the address information value is “2” and the command information is that “the rotor of the motor M is to be rotated to position X2” (giving ID 2 a position X2 instruction). As a result, all of the actuators A1 to An receive the control signal. In the actuators A1 and A3 to An, the value “2” for the address information in the received control signal does not match the actuator address value. The actuators A1 and A3 to An perform steps S3 and S6 and therefore do not take any meaningful actions (ignore communications). In the actuator A2, steps S3, S6, and S7 are executed. That is, the drive circuit 18 is provided with a drive signal corresponding to the command information (position control). Thus, in the actuator A2, the drive circuit 18 supplies the motor M with power to rotate the rotor of the motor M to position X2 and drive the air door (open or close).

Referring to FIG. 5C, for example, in accordance with a switch operation, the master controller 1 transmits a control signal indicating that the address information value is “n” and the command information is that “the rotor of the motor M is to be rotated to position Xn” (giving ID n a position Xn instruction). As a result, all of the actuators A1 to An receive the control signal. In the actuators A1 to A(n−1), the value “n” for the address information in the received control signal does not match the actuator address value. The actuators A1 to A(n−1) perform steps S3 and S6 and therefore do not take any meaningful actions (ignore communications). In the actuator An, steps S3, S6, and S7 are executed. That is, the drive circuit 18 is provided with a drive signal corresponding to the command information (position control). Thus, in the actuator An, the drive circuit 18 supplies the motor M with power to rotate the rotor of the motor M to position Xn and drive the air door (open or close).

In the actuator system 100, the number of lines is reduced by the daisy chain connection. Further, the actuator system 100 controls the plurality of actuators A1 to An independently of one another.

The actuator system 100 of the preferred embodiment has the advantages described below.
(1) In the actuators A1 to An, the address values of are sequentially set, and the input and output terminals 12 and 13 are sequentially connected to each other. Therefore, subsequently (until the next reset), a control signal for controlling a motor M is provided to all of the actuators A1 to An via the switches 14 regardless of the address information of the control signal. As a result, the drive signal corresponding to the command information of the control signal is provided to the drive circuit 18 to drive the motor M only in the actuator in which the value of the address information in the control signal matches its own address value. In this manner, in the actuator system 100 having the actuators A1 to An, all of the actuators A1 to An receive a control signal for controlling a motor M at substantially the same time (without a delay caused by the storage, determination, and transmission processes as in the prior art) regardless of the address information of the control signal. That is, in the actuator system 100 of the preferred embodiment, the load on the control circuit 16 in the control IC 19 is reduced in comparison with the conventional actuator system. Further, due to the elimination of the storage, determination, and transmission processes, the control signal reaches the actuators A1 to An in the following stage earlier. Thus, the responsiveness of each of the actuators A1 to An is satisfactory. The actuators A1 to An respond simultaneously to a signal. Accordingly, the improvement in the responsiveness becomes more prominent in actuators closer to the actuator An in the final stage as the number (n) of the actuators A1 to An increases. As a result, the air doors in the air conditioner passage are controlled with high responsiveness.
(2) The switch 14, the communication circuit 15, the control circuit 16, and the drive circuit 18 are integrated on the single control IC 19. In this manner, the unique switch 14 of the preferred embodiment is arranged on the control circuit 19, which is normally customized. This reduces costs in comparison to when the control circuit 16 and the switch 14 are arranged on different components.
(3) After the time elapses ensuring that step S1 has ended in the actuators A1 to An from when the master controller 1 is energized, the master controller 1 transmits the first address setting signal. Thus, erroneous operations that may be caused by the transmission of the address setting signal to the actuators A1 to An when resetting has not been completed does not occur. This ensures that the address values of the actuators A1 to An are set at different address values.

It should be apparent to those skilled in the art that the present invention may be embodied in many other specific forms without departing from the spirit or scope of the invention. Particularly, it should be understood that the present invention may be embodied in the following forms.

The switch 14 is arranged on the control IC 19 in the preferred embodiment. However, a different member (switching element that is independent from the control IC) may be employed as the switch 14. Such a configuration would also achieve advantages (1) and (3) of the preferred embodiment.

In the preferred embodiment, the control circuit 16 performs resetting when the vehicle ignition switch is turned on. However, the control circuit 16 may perform resetting at other times. For example, the control circuit 16 may perform resetting when the ignition switch is turned OFF. The control circuit 16 may also perform resetting in response to a reset signal from the master controller 1.

In the preferred embodiment, the input terminal 12, which is the terminal closer to the master controller 1, does not only receive the control signal. The input terminal 12 also functions as a terminal for transmitting a signal to the master controller 1 from the control circuit 16 via the communication circuit 15. Thus, for example, a position information signal generated by the sensor 17 when the rotor of the motor M is rotated may be transmitted to the master controller 1 via the communication circuit 15 and the input terminal 12.

In the preferred embodiment, in step S5, the control circuit 16 sets its address value from the initial value (“0”) to a predetermined value (e.g., “1”), which is included in the control signal, and closes (activates) the switch 14. However, a process for setting the address value to the predetermined value and a process for closing (activating) the switch 14 may be performed separately. In such a case, the master controller 1 first transmits the address setting signal and then transmits a control signal to the actuators A1 to An, of which address values have been set in accordance with the address setting signal, to close (activate) the switch 14. Such a configuration would achieve the same advantages as the preferred embodiment.

In the preferred embodiment, the actuator system 100 is used in a vehicle air conditioner. However, the present invention is not limited to such an application, and the actuators system 100 including the actuators A1 to An may be used for other applications.

In the preferred embodiment, the actuators A1 to An each include a motor M, which functions as a driving portion that produces rotational action. However, other devices may be used as the driving portion (e.g., motor that produces linear action or an electromagnetic solenoid).

In the preferred embodiment, the actuators A1 to An each include the switch 14. However, the switch 14 does not have to be included in the actuator. For example, the control circuit 16 of an actuator may be connected to a connector including the same switch as the switch 14. More specifically, for example, a switch included in the connector may be connected between a communication line 11 connected to the input terminal 12 and a communication line 11 connected to the output terminal 13. The control circuit 16 opens or closes the switch of the connector in accordance with a control signal.

In the actuator, it is only required that the switch be opened to disconnect the input and output terminal before the address value is set to a predetermined value and that the switch be closed to connect the input and output terminal after the address value is set to a predetermined value.

To configure the actuator system, sets of the actuator and the connector as described above may be connected in series to one another.

Furthermore, a connector including a setting circuit for setting the address value and a switch connected to the setting circuit may be connected to the actuator. After resetting is performed, the setting circuit opens a switch to disconnect the input and output terminals. After the address is set, the setting circuit closes the switch to connect the input terminal and the output terminal to each other. When the setting circuit determines that the value of the address information included in the control signal is its own address value, the setting circuit transmits the determination result to the control circuit of the actuator.

A setting device including the setting circuit and the switch may be used in devices other than the actuators, such as a heater, an optical device, or a speaker.

The present examples and embodiments are to be considered as illustrative and not restrictive, and the invention is not to be limited to the details given herein, but may be modified within the scope and equivalence of the appended claims.

1. An address setting device for setting an address of a device in accordance with a control signal, the setting device comprising:
an input terminal for receiving the control signal;
an output terminal for outputting the control signal; and
a setting circuit, connected to the input terminal and the output terminal, for setting an address value;
the setting circuit setting an initial value and disconnecting the input and output terminals from each other when reset; and
when the received control signal includes a predetermined value, the setting circuit changing the initial value to the predetermined value, which is used as the address value, and connecting the input and output terminals to each other.

2. The setting device according to claim 1, further comprising:
a switch connected between the input terminal and the output terminal, wherein the setting circuit opens the switch to disconnect the input and output terminals from each other when reset and closes the switch to connect the input and output terminals to each other when the address value is set.

3. The setting device according to claim 1, wherein the setting device is one of a plurality of setting devices connected in series to one another via the input and output terminals.

4. An actuator for which an address value is set based on a control signal, the actuator comprising:
an input terminal for receiving the control signal;
an output terminal for outputting the control signal;
a driving portion; and
a control circuit, connected to the input terminal, the output terminal, and the driving portion, for controlling the driving portion in accordance with the control signal, the control circuit setting its address value in accordance with the control signal;
the control circuit setting an initial value and disconnecting the input and output terminals from each other when reset; and
when the received control signal includes a predetermined value, the control circuit changing the initial value to the predetermined value, which is used as the address value of the actuator, and connecting the input and output terminals to each other.

5. The actuator according to claim 4, further comprising:
a switch connected between the input terminal and the output terminal, wherein the control circuit opens the switch to disconnect the input and output terminals from each other when reset and closes the switch to connect the input and output terminals to each other when the address value is set.

6. The actuator according to claim 5, further comprising:
a control IC on which the control circuit and the switch are integrated.

7. An actuator system comprising:
a plurality of series-connected actuators, wherein an address value is set for each of the actuators; and
a master controller, connected to the actuators, for providing the actuators with a control signal, each of the actuators including:
an input terminal for receiving the control signal;
an output terminal for outputting the control signal;
a driving portion; and
a control circuit, connected to the input terminal, the output terminal, and the driving portion, for controlling the driving portion in accordance with the control signal and for setting the address value of the actuator in accordance with the control signal;
the control circuit setting an initial value and disconnecting the input and output terminals from each other when reset; and
when the received control signal includes a predetermined value, the control circuit changing the initial value to the predetermined value, which is used as the address value, and connecting the input and output terminals to each other.

8. The actuator system according to claim 7, wherein each of the actuators further includes:
a switch connected between the input terminal and the output terminal, wherein the control circuit opens the switch to disconnect the input and output terminals from each other when reset and closes the switch to connect the input and output terminals to each other when the address value is set.

9. The actuator system according to claim 8, wherein at least one actuator of the plurality is arranged on an air door in an air conditioner passage of a vehicle, and the driving portion drives the air door.

10. The actuator system according to claim 9, wherein the control circuit is reset when an ignition switch of a vehicle is turned off or when the ignition switch is turned on.

11. The actuator system according to claim 10, wherein the master controller transmits the control signal to set the predetermined value as the address value after a time required for completing the resetting of the actuators elapses from when the ignition switch is turned off or on.

12. An actuator system for use in a vehicle air conditioner having air doors, the actuator system comprising:
a plurality of series-connected actuators, each being arranged on an air door to drive the air door, wherein an address value is set for each of the actuators; and
a master controller, connected to the actuators, for providing the actuators with a control signal, each of the actuators including:
an input terminal for receiving the control signal;
an output terminal for outputting the control signal;
a driving portion; and
a control circuit, connected to the input terminal, the output terminal, and the driving portion, for controlling the driving portion in accordance with the control signal and for setting the address value of the actuator in accordance with the control signal;
the control circuit setting an initial value and disconnecting the input and output terminals from each other when reset; and
when the received control signal includes a predetermined value, the control circuit changing the initial value to the predetermined value, which is used as the address value, and connecting the input and output terminals to each other.

13. The actuator system according to claim 12, wherein each of the actuators further includes:
a switch connected between the input terminal and the output terminal, wherein the control circuit opens the switch to disconnect the input and output terminals from each other when reset and closes the switch to connect the input and output terminals to each other when the address value is set.

14. A method for controlling a plurality of actuators, each including an input terminal and an output terminal, the actuators being connected in series with one another by the input and output terminals, the method comprising:
setting an initial value for each of the actuators and disconnecting the input and output terminals of each actuator;
changing the initial value of each actuator to a predetermined value, which is used as the address value of the actuator, and connecting the input and output terminals to each other.

15. The method according to claim 14, further comprising:
providing all of the actuators, at generally the same time in a state in which the input and output terminals of all of the actuators are connected to each other, with a control signal for controlling the actuators.
